(19) United States
(12) Patent Application Publication
(10) Pub. No.: US 2025/0050920 A1
(43) Pub. Date: Feb. 13, 2025

(54) METHOD AND DEVICE FOR MEASURING A TRACK

(71) Applicant: PLASSER & THEURER EXPORT VON BAHNBAUMASCHINEN GESELLSCHAFT M.B.H., Vienna (AT)

(72) Inventor: David Buchbauer, Steinakirchen am Forst (AT)

(21) Appl. No.: 18/723,556

(22) PCT Filed: Dec. 19, 2022
(86) PCT No.: PCT/EP2022/086562

§ 371 Date: Jun. 24, 2024

(30) Foreign Application Priority Data
Dec. 22, 2021 (AT) A 51038/2021

(51) Int. Cl. B61K 9/08; G01B 11/02

(52) U.S. Cl. CPC B61K 9/08; G01B 11/022

(57) ABSTRACT

A method for the contactless detection of a position of a measurement device that can be moved by a rail running gear on a track relative to at least one rail of the track. A projection of a laser beam that is projected onto the at least one rail and onto the inner side of a wheel of the rail running gear is detected by way of a camera. A detected position of the measurement device with respect to the wheel inner side is evaluated by an evaluation device. The inner side of the wheel disc is used as a reference base for determining at least one position value of the measurement device.

### FIELD OF TECHNOLOGY

The invention relates to a method for the non-contact recording of a position of a measuring device, which can be moved on a track by means of a rail running gear, in relation to at least one rail of the track, with a projection of a laser beam projected onto the at least one rail being recorded by means of a camera. The invention further relates to a device for carrying out the method.

### STATE OF THE ART

In order to assess the condition of a railway track, measurements are taken at regular intervals. Signs of wear and changes in position recorded in the process form the basis for planning and implementing necessary maintenance measures.

Usually, measuring devices are used that are arranged on rail vehicles and can therefore be moved along the track. Specialized track recording vehicles are equipped with numerous measuring devices whose measuring results are combined to provide an overall picture of the track condition. It is necessary to precisely record the position of the respective measuring device in relation to at least one rail of the track in order to be able to derive an absolute or relative track position or signs of wear. Corresponding measuring devices are also used to record a gauge or a progression of a gauge, with the position in relation to both rails being evaluated.

Corresponding measuring devices are known from AT 14280 U1 and DE 1 165 064 B, which work with laser technology, camera systems, or ultrasound. Another device for track geometry measuring is described by Oberlechner G. et al: POS/TG—Innovation in the field of track geometry measurement, El-Eisenbahningenieur (52) 9/2001, pages 6-9. Such non-contact solutions are not subject to wear. However, the requirements for control and evaluation devices are high. In particular, these measuring devices require a calibration process so that the position can be determined in relation to a reference base during readjustment.

### SUMMARY OF THE INVENTION

The object of the invention is to improve a method of the kind mentioned above in such a way that the degree of automation is increased. A corresponding device must also be specified.

According to the invention, these objects are achieved by way of a method according to claim 1 and a device according to claim 6. Dependent claims indicate advantageous embodiments of the invention.

The projection is projected onto the rail and onto the inner side of a wheel of the rail running gear, with a recorded position of the measuring device in relation to the wheel inner side being evaluated by means of an evaluation device. This method uses the inner side of the wheel disc as a reference base for determining at least one position value of the measuring device. In addition to a spacing between measuring device and wheel, a mounting angle of the measuring device can also be recorded, in particular due to the known alignment of the wheel inner side. Any rate of change of the inner wheel surface is extremely small and can be determined during operation if necessary. This self-monitoring of the measuring system prevents an incorrect recording of the position in relation to the assigned rail.

In a further development of the method, the position of the measuring device in relation to the inner side of the wheel is recorded for automated calibration of the measuring device, with a recorded spacing and/or angle of the measuring device in relation to the wheel inner side being compared with a stored value by means of the evaluation device. With this auto-calibration process, the measuring device determines its own position in space. This is particularly useful after replacing a sensor or readjusting the measuring device.

Advantageously, the position in relation to both rails of the track is recorded by means of two coupled measuring devices and the gauge of the track is determined therefrom. The respective measuring device determines its position in relation to the assigned wheel disc. A resulting offset dimension serves as the basis for deriving the total gauge.

In a further development of this method, the position of the respective measuring device in relation to the inner side of the assigned wheel is recorded for the automated calibration of both measuring devices, with a recorded spacing and/or angle of the respective measuring device in relation to the assigned wheel inner side being compared with a stored value by means of the evaluation device. Experience has shown that the alignment of the wheels arranged on a common axle always remains constant. Any deviations over time are negligible, which is why the inner sides of the wheel pair provide a permanent reference base.

With the specified auto-calibration methods, it is useful to carry out an automated recalibration of the recorded spacing and/or angle at predefined time intervals. This ensures that any drift does not result in any inaccuracies. The computing power required for this remains low because the individual calibration processes take place at sufficiently long intervals.

The device according to the invention for non-contact recording of a position of a measuring device in relation to a rail of a track comprises the measuring device and a rail running gear which can be moved on the track and to which the measuring device is coupled, with the measuring device comprising a laser device for projecting a laser beam and a camera for recording the projection and being aligned in relation to the rail running gear in such a way that the laser beam can be projected both onto the rail and onto the inner side of a wheel of the rail running gear, and with an evaluation device being arranged for evaluating a recorded position of the measuring device in relation to the wheel inner side. A known light-section sensor (laser scanner, mirror scanner) is advantageously used as a measuring device for the optical measuring of a surface. New is the arrangement of the measuring device and the evaluation device, which is set up to determine the position of the measuring device in relation to the inner wheel surface.

In a preferred further development of the device, the measuring device comprises a closed housing with at least one viewing window for the laser beam and for a recording area of the camera. This shields the measuring device's sensors from interfering environmental influences, in particular moisture, dust, and solar radiation.

In a further improvement, at least one measuring device is arranged on a common measuring frame for each rail of the track. The common measuring frame forms a rigid base for the measuring devices so that the position of the measuring devices in relation to each other remains unchanged.

Advantageously, an inertial measurement unit (IMU) is arranged on the measuring frame to record a trajectory. With this extension, in addition to the position of the rails in relation to the measuring units and the gauge, the course of the rails can also be recorded. A trajectory for each rail is derived from the trajectory recorded by the inertial measurement unit using the measurement results of the respective measuring device.

A further improvement provides that an automated calibration routine is set up in the evaluation device, with which a recorded spacing and/or angle of the respective measuring device to the assigned inner wheel surface can be compared with a stored value. This auto-calibration enables the device to be operated with sufficient measuring accuracy even after interference.

### BRIEF DESCRIPTION OF THE DRAWINGS

In the following, the invention is explained by way of example with reference to the accompanying figures. The following figures show in schematic illustrations:

FIG. 1 Rail vehicle

FIG. 2 Measuring arrangement in a diagonal view

FIG. 3 Measuring arrangement in a front view

FIG. 4 Measuring arrangement in a top view

### DESCRIPTION OF THE EMBODIMENTS

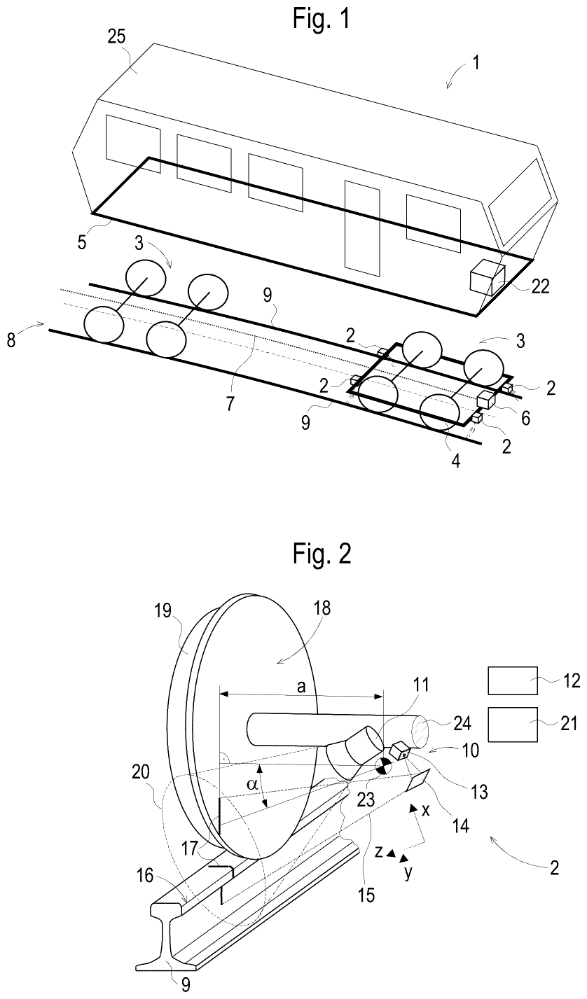

FIG. 1 shows a rail vehicle as a device 1 with a measuring platform on which four measuring devices 2 are arranged. A measuring frame 4 arranged on a rail running gear 3 serves as the measuring platform. In another embodiment, a vehicle frame 5 serves as a measuring platform. The rail vehicle is, for example, a track recording vehicle featuring additional measuring devices (e.g. ultrasonic measuring devices for inspecting the rail material, rotating lasers, etc.). In particular, an inertial measurement unit 6 for recording a trajectory 7 is arranged on the measuring frame 4.

In a reduced embodiment not shown, the device 1 is a manual measuring trolley with a rail running gear 3 and at least one measuring device 2. During a measuring process, the measuring device 2 coupled to the rail running gear 3 is moved along a track 8. The measuring device 2 is used to determine the position in relation to at least one rail 9 of the track 8. In the example shown, four measuring devices 2 are arranged on the common rigid measuring frame 4. They are used to record the exact position of all measuring devices 2 in relation to the rails 9 of the track 8.

The respective measuring device 2 is designed as a light-section sensor and comprises a laser device 10, a camera 11, and a control device 12. In the variant shown, the laser device 10 comprises a laser source 13 and a deflecting mirror 14. The laser device 10 projects a fanned laser beam 15 onto an inner rail head edge 16 of the rail 9. Specifically, the laser source 13 is designed as a so-called line laser. A special optical system generates a linear projection 17 instead of a point, with various geometric shapes being possible. In the present invention, a simple line, a rectangle, or a triangle, for example, is useful as a linear projection 17.

According to the invention, the projection 17 is not only projected onto the rail 9, but also onto an inner side 18 of a wheel 19 of the rail running gear 3. The section projected onto the wheel inner side 18 is recorded by the camera 11. For this purpose, a recording area 20 of the camera 11 is directed towards both the rail 9 and the wheel inner side 18. Based on the recorded image data, the position of the measuring device 2 in relation to the inner wheel surface 18 is determined in an evaluation device 21 using photogrammetry.

For example, a combined control and evaluation device 12, 21 with a powerful microprocessor is arranged in the measuring device 2 itself. However, the evaluation device 21 can also be set up in a separate computing unit 22 in the rail vehicle. In an off-line variant, the recorded data is stored on a data carrier. The data is then evaluated in a central unit in an evaluation unit 21. The data is preferably linked to a respective location coordinate, which is recorded using a GNSS system or a distance sensor, for example.

In another variant, the measuring data is transmitted to a central unit via an air interface and evaluated there. Position data or gauge data already evaluated in real time can also be transmitted to a central unit and used for maintenance planning.

In order to utilize further aspects of the present invention, the measuring device 2 can be integrated into a measuring system of a track construction and maintenance machine. The measuring data can then be used directly for various maintenance measures, for example, for surveying or post-measuring a track during track tamping work or ballast bed cleaning work.

FIG. 2 shows the arrangement of the laser device 10 and the camera 11 of a single measuring device 2 in relation to an assigned wheel 19 of the rail running gear 3. The laser source 13 projects a projection 17 onto the inner rail head edge 16 and simultaneously onto the inner surface 18 of the wheel 19 via the deflecting mirror 14. In the example, the section projected onto the wheel 19 is a straight line. A zero point 23 and a coordinate system xyz are defined in the measuring device 2. In addition, the inner surface 18 of the wheel 19 is a plane in which the projected straight line lies. Using this relationship, a normal spacing a between the zero point 23 and the inner surface 18 of the wheel 19 can be determined in the evaluation device 21 by means of photogrammetry.

Furthermore, an angle α can be determined, which indicates the inclination of the measuring device 2 in relation to the inner surface 18. For example, the angle α includes a coordinate axis z and a normal line on the inner surface 18.

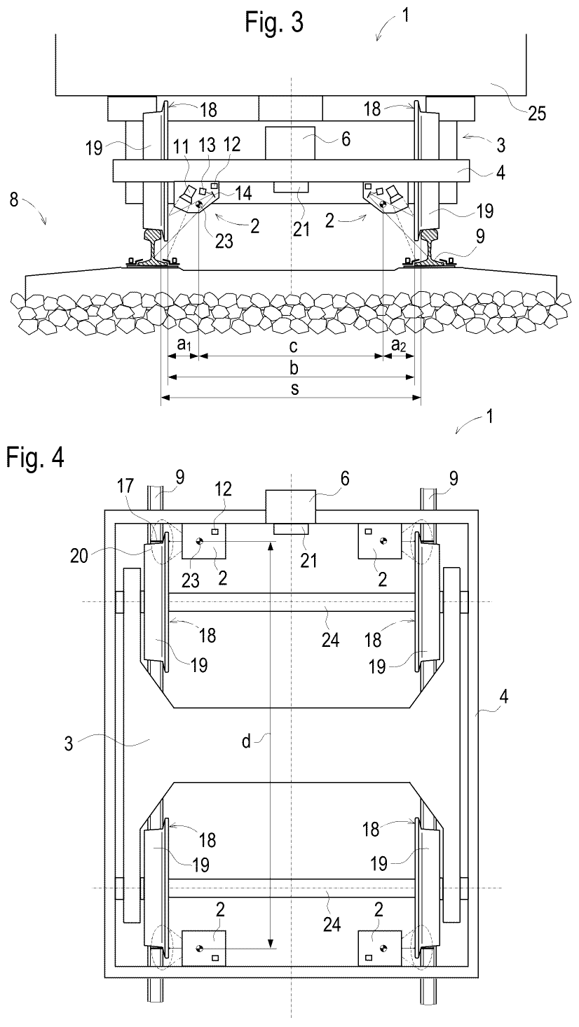

An exemplary calibration method is explained with reference to FIG. 3. Here, a measuring device 2 is assigned to each rail 9. Using the measuring method described, a spacing a1, a2 to the assigned inner wheel surface 18 is determined for each measuring device 2. The known constant inner spacing b between the wheel discs 19 results in a spacing c between the measuring devices 2. In this way, each measuring device 2 can be newly calibrated after a sensor replacement or a mounting adjustment. In addition, recalibration can be carried out at any time.

The spacing c between the measuring devices 2 can further be used to determine the gauge s of the track 8 by evaluating the projections 17 onto the inner rail head edges 16. A method for determining the position of a light-section sensor in relation to an inner rail head edge 16 is known, for example, from AT 520266 A1.

FIG. 4 shows a top view of the exemplary device 1. Two measuring devices 2 are assigned to each rail 9 at a fixed spacing d from each other. Each measuring device 2 comprises its own laser device 10, which projects a projection 17 onto the assigned rail 9 and onto the assigned inner wheel surface 18. This means that the position of each measuring device 2 can be calibrated separately. All measuring devices 2 are arranged on the common measuring frame 4. This measuring frame 4 is directly coupled to the axles 24 of the wheels 19 of the rail running gear 3. As a result, the suspension travel of the rail running gear 3 has no influence on the position of the measuring frame 4 in relation to the rails 9. The measuring frame 4 can therefore be used as a reference plane for track measuring.

The gauge s is measured simultaneously at two points at a spacing d using this device 1. This makes it possible to determine the course of the rails 9 from a standstill at low forward speed without recording the trajectory 7. Starting from a minimum speed, the trajectory 7 recorded by the inertial measurement unit 6 can be transferred to each rail 9 via the measuring values recorded by the measuring devices 2.

The rail running gear 3 applies load to the track 8 during a measuring run. Track geometry measuring is thus carried out under realistic loads. It is not necessary to compensate for suspension travel or movements of a vehicle body 25.

1-10. (canceled)

11. A method for a non-contact detection of a position of a measuring device relative to at least one rail of a track, wherein the measuring device is movable on a track by way of a rail running gear, the method comprising:
projecting a laser beam onto the at least one rail and onto the inner side of a wheel of the rail running gear;
recording a projection of the laser beam projected onto the at least one rail by a camera; and
evaluating a recorded position of the measuring device in relation to the wheel inner side by an evaluation device.

12. The method according to claim 11, which comprises recording the position of the measuring device in relation to the inner side of the wheel for an automated calibration of the measuring device and comparing at least one of a recorded spacing or an angle of the measuring device in relation to the wheel inner side with a stored value by the evaluation device.

13. The method according to claim 12, which comprises carrying out an automated recalibration of at least one of the recorded spacing or the angle at predefined time intervals.

14. The method according to claim 11, which comprises recording a position in relation to both rails of the track by two coupled measuring devices and determining therefrom a gauge of the track.

15. The method according to claim 14, which comprises, for an automated calibration of two measuring devices, recording a position of the respective measuring device in relation to the inner side of the assigned wheel and comparing by the evaluation device at least one of a recorded spacing or an angle of the respective measuring device in relation to the assigned wheel inner side with a stored value.

16. The method according to claim 14, which comprises carrying out an automated recalibration of at least one of the recorded spacing or the angle at predefined time intervals.

17. A device for non-contact recording of a position of a measuring device relative to a rail of a track, the device comprising:
a laser device for projecting a laser beam and a camera or recording a projection of the laser beam;
the measuring device being coupled to a rail running gear that is movable on the track and the measuring device being aligned in relation to the rail running gear in such a way that the laser beam can be projected both onto the rail and onto an inner side of a wheel of the rail running gear; and
an evaluation device configured for evaluating a recorded position of the measuring device in relation to the inner side of the wheel.

18. The device according to claim 17, wherein said measuring device comprises an enclosed housing with at least one viewing window for the laser beam and for a recording area of the camera.

19. The device according to claim 17, wherein at least one measuring device is arranged on a common measuring frame for each rail of the track.

20. The device according to claim 19, which further comprises an inertial measurement unit for recording a trajectory arranged on said measuring frame.

21. The device according to claim 17, wherein said evaluation device is configured to perform an automated calibration routine, wherein at least one of a recorded spacing or an angle of the respective measuring device to the assigned inner wheel surface is compared with a stored value.
